(19) United States
(12) Patent Application Publication
(10) Pub. No.: US 2004/0117452 A1
(43) Pub. Date: Jun. 17, 2004

(54) XML-based network management system and method for configuration management of heterogeneous network devices

(76) Inventors: Byung Joon Lee, Daejeon-City (KR); Tae Sang Choi, Daejeon-City (KR); Tae Soo Jeong, Daejeon-City (KR)

Correspondence Address: Eric S. Hyman, BLAKELY, SOKOLOFF, TAYLOR & ZAFMAN LLP, Ste 700, 12400 Wilshire Blvd., Los Angeles, CA, 90025, US

(21) Appl. No.: 10/612,847

(22) Filed: Jul. 3, 2003

(30) Foreign Application Priority Data
Dec. 11, 2002 (KR) 2002-78703

(51) Int. Cl. G06F 15/16

(52) U.S. Cl. 709/208

(57) ABSTRACT

Extensible markup language (XML)-based network management system and method in which maintenance of the network management system can be improved are provided. The network management system comprises an XML template in which the form of a command line interface (CLI) command supported by a network device is expressed in XML; and a network management interface, which converts the XML template into a tree-shaped internal data structure, and by providing a predetermined argument to the converted XML template, converts the XML template into a set of CLI commands that are to be transmitted to the network device.

This application claims priority from Korean Patent Application No. 02-78703, filed on Dec. 11, 2002, the contents of which are incorporated herein by reference in their entirety.

### BACKGROUND OF THE INVENTION

1. Field of the Invention

The present invention relates to a network management system and method, and more particularly, to an extensible markup language (XML)-based network management system and method in which maintenance of the network management system can be improved.

2. Description of the Related Art

There are a variety of methods of transmitting configuration commands to a network device, including Simple Network Management Protocol (SNMP), and a Common Object Policy Service (COPS) protocol. The SNM protocol has an advantage in that it is relatively simple and easy to grasp. However, when it comes to the transmission of network-related policy information, which has been increasingly complicated of late, to network devices, the SNM protocol is too simple and has poor security-related functions. The COPS protocol has been proposed by the Internet Engineering Task Force (IETF) in order to solve this problem. The COPS protocol has an object-oriented message structure with a well-defined shape. However, as of yet many devices have supported the SNM protocol instead of the COPS protocol.

Meanwhile, almost all devices support a command line interface (CLI), which is a TELNET-based manual interface for device management, and the CLI most quickly reflects the latest standards. Accordingly, most of network management systems use a non-standardized substitute measure in which a device is managed by accessing the device using the TELNET protocol, and policy information is converted into a series of CLI commands and then transmitted to the device. However, since these CLI-based network management systems use a method by which policy information is converted into CLI commands using a program, these systems have a disadvantage in that the program of the network management software directly depends on the CLI syntax. Accordingly, when the operating system of a device is upgraded to the latest version, in order to reflect the changes in the CLI syntax the network management system should be changed. Therefore, a new method by which these problems can be solved and the improvement of the maintenance of a CLI-based network management system is needed.

### SUMMARY OF THE INVENTION

The present invention provides a network management system and method, in which combining an XML template stored in a memory with an argument sent to the XML template to generate materialized CLI commands makes it so that the program of network management software does not depend on the CLI syntax and the maintenance of the CLI-based network management system is improved.

The present invention also provides a computer readable recording medium having embodied thereon a computer program for executing the method in a computer.

According to an aspect of the present invention, there is provided a network management system comprising an extensible markup language (XML) template in which the form of a command line interface (CLI) command supported by a network device is expressed in XML; and a network management interface which converts the XML template into a tree-shaped internal data structure, and by providing a predetermined argument to the converted XML template, converts the XML template into a set of CLI commands that are to be transmitted to the network device.

According to another aspect of the present invention, there is provided a network management method comprising (a) forming an extensible markup language (XML) template in which the form of a command line interface (CLI) command supported by a network device is expressed in XML; and (b) converting the XML template into a tree-shaped internal data structure, and by providing a predetermined argument to the converted XML template, converting the XML template into a set of CLI commands that are to be transmitted to the network device.

In the method, step (b) may comprise (b-1) converting the XML template into the tree-shaped internal data structure; (b-2) providing a predetermined argument to the converted XML template and converting the XML template into the set of CLI commands; (b-3) transmitting the converted CLI commands to the network device; and (b-4) determining whether the transmitted CLI commands are successfully executed and collecting additional information.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a network management system according to a preferred embodiment of the present invention;

FIG. 2 is a diagram showing a detailed structure of a network management interface shown in FIG. 1;

FIG. 3 is a diagram showing the syntax structure of the XML template shown in FIG. 1;

FIG. 4 is a diagram showing an example of a CLI command and an example of an XML template expressing the CLI command;

FIG. 5 is a diagram for explaining a method for materializing CLI commands according to the present invention;

FIG. 6 is a flowchart for showing a process in which materialized CLI commands are executed according to a network management interface method of the present invention; and

FIG. 7 is a diagram for showing a process in which each element of a network management system according to the present invention is called when CLI commands are materialized and the materialized CLI commands are executed.

### DESCRIPTION OF THE PREFERRED EMBODIMENTS

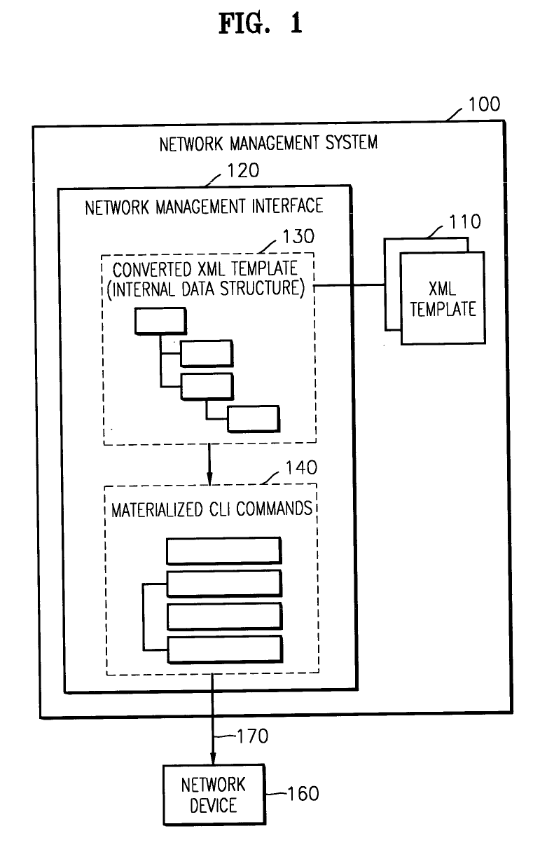

FIG. 1 is a block diagram of a network management system 100 according to a preferred embodiment of the present invention and shows a method of configuring the network management system 100 by using a network management interface 120, and the relationship between the network management system 100 and a network.

Referring to FIG. 1, the network management system 100 loads an XML template 110 on a memory, using an X-CLI interface as a network management interface 120. In the XML template 110, the CLI commands forms supported by a network device are expressed in XML, and the relationship between CLI commands needed in performing predetermined functions in the device are specified. This template 110 is converted into a tree-shaped internal data structure and is then managed internally in the network management interface 120. If the network management system 100 transfers a corresponding argument to the converted XML template 130 via the network management interface 120, the template 130 is converted into a set of CLI commands that can be transmitted to the network device 160. The converted set of CLI commands are referred to as materialized CLI commands 140. Thus, if a process, in which a part depending on the CLI syntax is separated in the form of a file that is the XML template 110 and then converted into the actual CLI commands, is automated, network management software can be made to be independent of the CLI syntax.

The materialized CLI commands 140 call the network management interface 120 and are then transmitted to the network device 160. The network management system 100 and the network device 160 communicate with each other through a TELNET connection 170 established by the network management interface 120. In addition to TELNET, any protocols that provide a virtual terminal function to the network device 160, for example, secure shell (SSH), can be used for means of the communication.

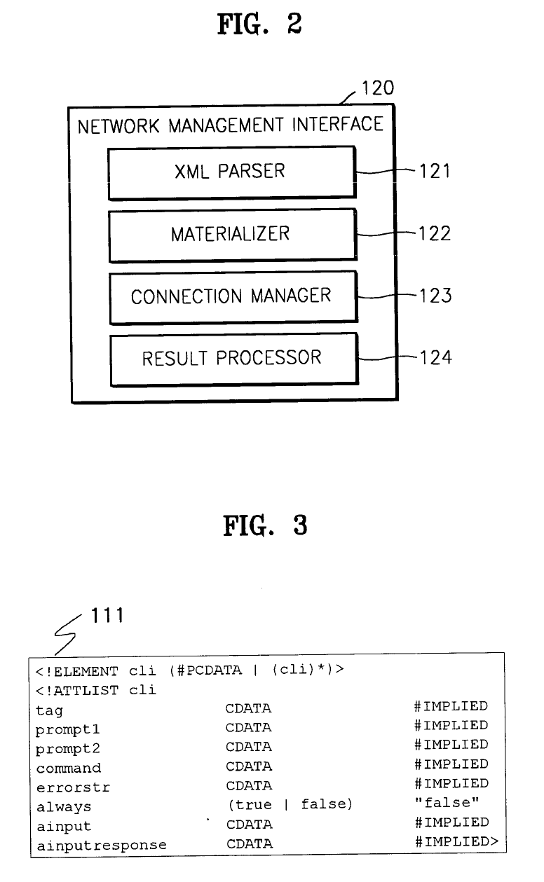

FIG. 2 is a diagram showing a detailed structure of a network management interface shown in FIG. 1. Referring to FIG. 2, the network management interface 120 comprises an XML parser 121, a materializer 122, a connection manager 123, and a result processor 124.

The XML parser 121 loads the XML template 110 into a memory and converts the XML template 110 into a tree-shaped internal data structure 130. The materializer 122 transfers an argument to the converted XML template 130 so that the converted XML template 130 is converted into CLI commands, that is, the converted XML template 130 is materialized. The connection manager 123 transmits the materialized CLI commands 140 to the network device 160. Then, the result processor 124 determines whether the CLI commands 140 are successfully executed by parsing the execution result of the transmitted CLI commands 140, or collects additional information that can be obtained from the execution results.

FIG. 3 is a diagram showing the syntax structure of the XML template 110 shown in FIG. 1. The XML template 110 according to the present invention is specified by using a document type declaration (DTD), which is one of the XML standards. DTD is used to show the list of tags forming an XML document and to list the attributes of respective tags. DTD shown in FIG. 3 specifies the syntax of the XML template 110 as an ELEMENT tag, an ATTLIST tag, a CDATA tag, and a #IMPLIED tag.

First, the ELEMENT tag indicates that a <cli> tag may appear in the XML document, and the <cli> tag may or may not include subordinate <cli> tags or character string data.

The ATTLIST tag is used to specify the attributes of the <cli> tag. The attributes of the <cli> tag which are specified by the ATTLIST tag include tag, prompt1, prompt2, command, errorstr, always, ainput, and ainputresponse.

The CDATA tag indicates that the corresponding attributes have character string values. The Attributes which are specified as #IMPLIED can be omitted. When a predetermined value is specified instead of #IMPLIED as the always tag in FIG. 3, the predetermined value is used as a default value. That is, if a corresponding attribute value is not specified when the <cli> tag is used, it is assumed that the corresponding default value is given. Each attribute of the <cli> tag will now be explained individually.

The ‘tag’ is used as an identifier for identifying the <cli> tag in a document. The ‘tag’ is used to identify a predetermined tag in order to send an argument when a plurality of <cli> tags exist at the same time. The ‘command’ is an attribute for indicating an actual CLI command. The ‘prompt1’ is an attribute which is used to display the corresponding prompt character string on a virtual terminal 170 of the network device 160 in order to transmit a CLI command specified as a command attribute value. The ‘prompt2’ is used to specify whether a predetermined prompt should be displayed on the virtual terminal 170 of the network device 160 after a CLI command is transmitted and executed. The ‘errorstr’ is used to specify which character string can be displayed on the virtual terminal 170 of the network device 160 when the result of executing a CLI command is a failure. Using this attribute value, the success or failure of executing an individual CLI command is determined. The ‘always’ is used to determine whether a current CLI command will be executed when an arbitrary CLI command executed previously is a failure. For example, if the value of the ‘always’ attribute is ‘true’, the corresponding CLI command is executed regardless of whether the result of execution of a CLI commands that was previously executed was a success or a failure. If the value is ‘false’, the corresponding CLI command is executed only when CLI commands that were executed previously were all successfully executed. This ‘always’ attribute has the ‘false’ value as the basic value.

A<cli> tag in which the attributes are all omitted is referred to as a pure aggregation tag and is referred to as PAT, an abbreviation. PAT indicates that subordinate <cli> tags included in the tag may be materialized more than once. In other words, PAT indicates that if arguments are continuously given, the tags may be materialized multiple times.

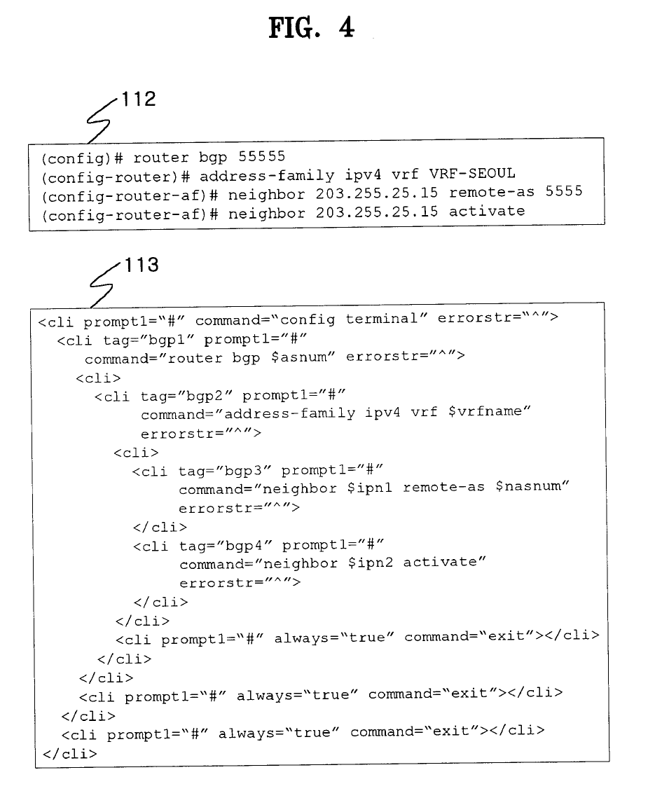

FIG. 4 is a diagram showing an example of a CLI command 112 and an example 113 of an XML template 110 expressing the CLI command. The CLI command 112 shown in FIG. 4 is an example of a command for setting a boarder gateway protocol (BGP)-related function in a Provider Edge (PE) router of Cisco Systems, Inc. This example clearly shows how CLI commands are related hierarchically.

For example, a command ‘address-family ipv4 vrf VRF-SEOUL’ cannot be input unless a higher level command ‘router bgp 55555’ is executed. This type of hierarchical relationship is referred to as hierarchical dependency. In addition, if a command fails during its execution, CLI commands after said command cannot be input. Accordingly, whether a subsequent command is executed is dependent on the result of execution of a preceding command. This type of relationship is referred to as result dependency. Also, the part ‘55555’in the command ‘ router bgp 55555’ can be regarded as an argument for the router bgp command. In this case, if this argument is omitted, the router bgp command cannot be executed and a dependency between the argument and execution of the command occurs. This type of dependency is referred to as argument dependency.

Therefore, in the present invention, by using the syntax of the XML template 110 shown in FIG. 3, the contents of the hierarchical dependency, argument dependency, and result dependency of theses CLI commands are described in the XML form. If the CLI command 112 shown in FIG. 4 is expressed by the XML template based on the syntax of the XML template 110 shown in FIG. 3, it is specified as shown in the example 113.

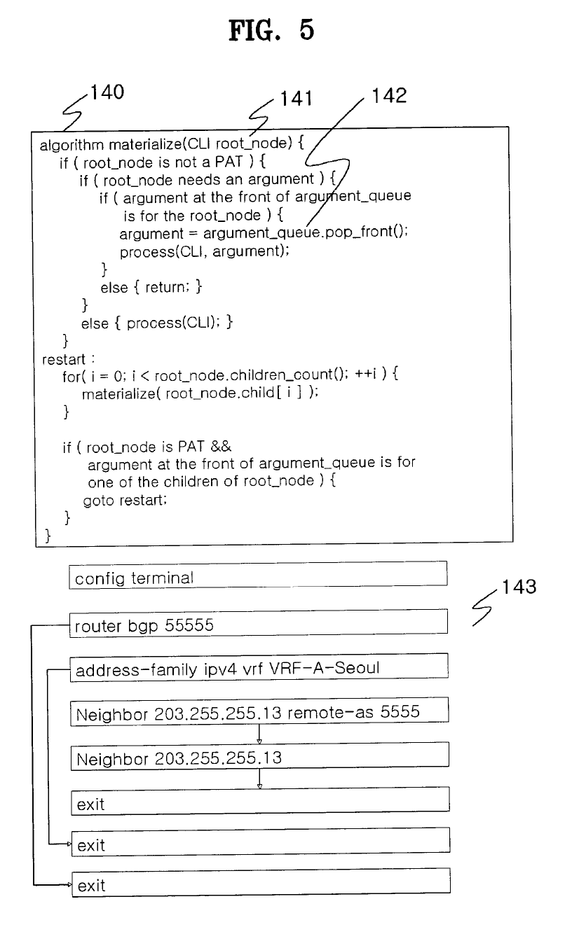

The hierarchical dependency of a CLI command is described by the inclusion relationship between <cli> tags. For example, a CLI command included in an arbitrary CLI command cannot be materialized if the arbitrary CLI command containing the CLI command is not materialized, and, even though the CLI command is materialized, it cannot be executed if the arbitrary CLI command containing the CLI command is not successfully executed. Considering these facts, it can be said that materialization is equivalent to the concept of ‘compile’ in an ordinary programming language, and execution of materialization is equivalent to ‘program execution’ in an ordinary programming language. A process of materialization will be explained in detail referring to FIG. 5.

The argument dependency of a CLI command is expressed by a form argument name which begins with $ that is included in a command attribute value. This form argument name is replaced later by an argument sent to a loaded XML template 130 after the XML template 110 is loaded onto a memory by an X-CLI application programming interface (API). If the argument is not properly sent, the corresponding CLI command cannot be materialized.

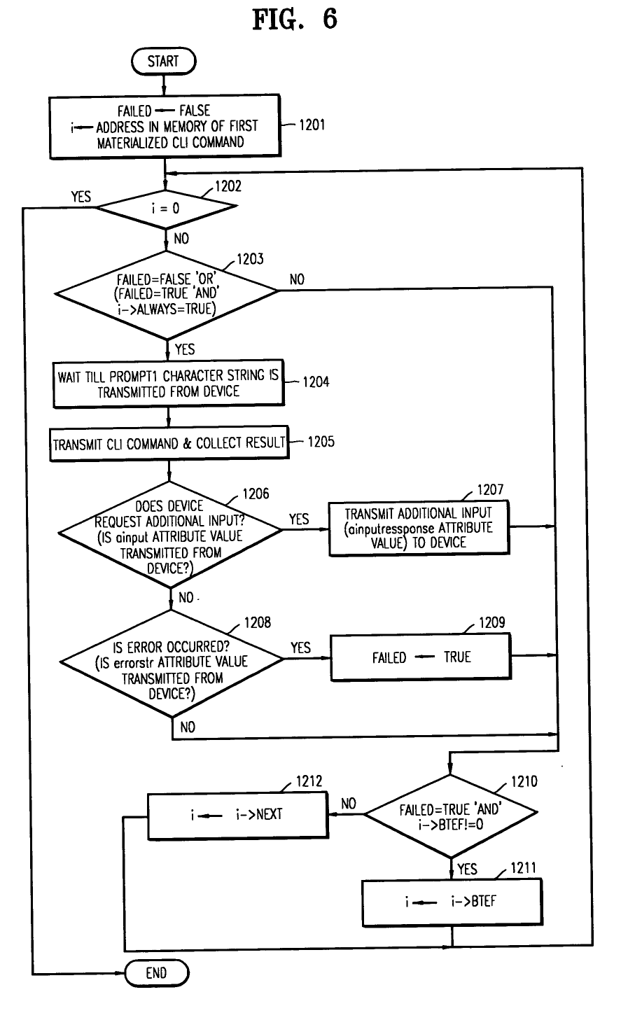

The result dependency of a CLI command is expressed by ‘errorstr’ attribute and an ‘always’ attribute of a <cli> taq. If the execution of a materialized CLI command that was previously executed is a failure (for example, if the execution result includes a value specified in the ‘errorstr’ attribute, the result is regarded as a failure), only CLI commands in which the ‘always’ attribute values are ‘true’ are executed after the failed command. Details of result dependency will be explained referring to FIG. 6.

FIG. 5 is a diagram for explaining a method of materializing CLI commands according to the present invention. In the process of materializing a CLI command according to the present invention, the materializer 122 of the network management interface 120 shown in FIG. 2 combines the XML template 130 stored as a tree-shaped internal data structure in the memory, with an argument provided to the template 130 such that a sequence 140 of materialized CLI commands is generated. A process of obtaining the sequence 140 of materialized CLI commands will now be explained.

First, an XML template, which is the object of materialization, is provided in the form of a tree of CLI commands, and a queue 142 of arguments is provided. If a <cli> tag corresponding to a root node of a tree that is to be materialized is not a PAT, it is determined whether the <cli> tag needs an argument. If the <cli> tag needs an argument, by searching the queue 142 of arguments, it is determined whether the needed argument is in the queue 142. If the needed argument is in the queue 142, materialization is preformed by applying the argument to the <cli> tag. If materialization of the root node is completed through this process, this materialization process is recursively applied to all children nodes of the root node.

After the application of materialization process is successfully completed, if the root node is a PAT, there is the possibility for children nodes to be materialized again, and therefore, the process is again performed from the location of ‘restart:’. The result of applying this materialization process to 113 of FIG. 4 is the same as 143 of FIG. 5.

As described above, the method of materializing CLI commands according to the present invention converts the tree-shaped hierarchical relationship among the CLI commands formed by the XML template 110, into the execution trace of continuous CLI commands. As described above, however, if a CLI command fails in the middle of execution, those commands which belong to lower layers in the hierarchy should not be executed. Accordingly, in the present invention, a branch location for a failure case is automatically generated and managed as an additional attribute for each CLI command. This branch location for a failure becomes a next sibling node sharing a parent node. The sequence 140 of materialized CLI commands in FIG. 5 shows how the branch locations are generated. The execution order of the materialized CLI commands 140 will now be explained.

FIG. 6 is a flowchart for showing a process in which materialized CLI commands are executed according to a network management interface method of the present invention, and shows a process in which actual materialized CLI commands 140 are transmitted one by one to the network device 160 by the connection manager 123 and then executed.

Referring to FIG. 6, first, the connection manager 123 sets a ‘failed’ variable value to ‘false’ and allocates the address value of a first command among the actual materialized CLI commands, to variable i in step 1201. Then, it is determined whether or not i is 0 in step 1202.

If the determined result of step 1202 indicates that i is 0, execution of CLI commands is stopped. If i is not 0, while i is not 0 (that is, while i indicates an effective command), the steps in the following loop are performed. In order to perform the steps in the following loop, first, it is initially determined whether or not the ‘failed’ variable value that is set to ‘false’ in step 1201 stays at ‘false’ without change in step 1203.

If the determined result of the step 1203 indicates that the ‘failed’ variable value set in the step 1201 stays at ‘false’, the connection manager 123 waits till a prompt character string specified as a ‘prompt1’ attribute value is transmitted from the network device 160 in step 1204. Then, if the prompt character string is transmitted, the CLI command 140 is transmitted, and the execution result of the CLI command 140 is collected in step 1205. Then, it is determined whether the network device 160 requests an additional input (that is, whether an ‘ainput’ attribute value is transmitted from the network device 160) in step 1206

If the determined result of step 1206 indicates that the network device 160 requests an additional input, a character string specified as a ‘ainputresponse’ attribute value as an additional input is transmitted to the network device 160 in step 1207. If the determined result of step 1206 indicates that the network device 160 does not request an additional input, it is determined whether an error occurred in the execution of the CLI command (that is, whether or not an ‘errorstr’ attribute value is transmitted from the network device 160) in step 1208.

If the determined result of step 1208 indicates that an error occurred in the execution of the CLI command, the ‘failed’ variable value is set to ‘true’. If the determined result of step 1208 indicates that no error occurred in the execution, the state of the ‘failed’ variable and the branch location for a failure of execution (BTEF) of the CLI command 140 are checked in step 1210.

If the result of checking the state of the ‘failed’ variable and the BTEF of the CLI command 140 in the step 1210 indicates that the ‘failed’ variable value is ‘true’ and the branch location for a failure of executing the CLI command 140 is 0, the BTEF of CLI command 140 is stored in i and step 1202 is performed again in step 1211. If the result of checking in the step 1210 indicates that the ‘failed’ variable value is ‘true’ and the BTEF of CLI command 140 is not 0, the address value (NEXT) of a CLI command to be executed next is stored in i and the step 1202 is performed again in step 1212.

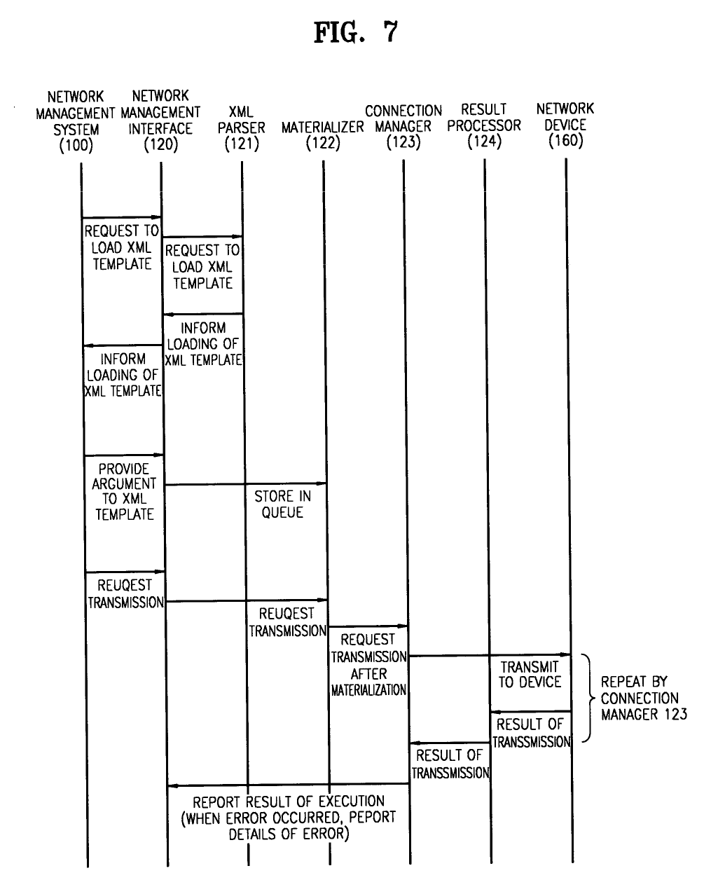

FIG. 7 is a diagram for showing a process in which each element of the network management system 100 according to the present invention is called when CLI commands are materialized and the materialized CLI commands are executed.

Referring to FIG. 7, operations performed in the network management system 100 according to the present invention can be divided into 3 processes, including a process for requesting to load the XML template 110 via the network management interface 120, a process for transmitting an argument to the XML template 110, and a process for transmitting materialized CLI commands 140.

A process for materializing the XML template 110 to CLI commands 140 is performed internally by the materializer 122 in the network management interface 120 before actual transmission is performed. The procedure by which each element of the network management system 100 is called when the elements of the network management system 100 perform materialization of a CLI command and execute the materialized CLI commands will now be explained.

First, if a request to load the XML template 110 is generated from the network management system 100, the load request is transferred to the XML parser 121 via the network management interface 120. The XML parser 121 converts the XML template 110 into a tree-shaped internal data structure 130, loads the converted XML template 110 onto the memory, and informs the network management system 100 via the network management interface 120 that the XML template 100 is loaded onto the memory.

The network management system 100 sends an argument to the XML template 110 via the network management interface 120. The network management interface 120 stores the argument in a queue and sends it to the materializer 122. The materializer 122 performs a role for converting (that is, materializing) the XML template 130 into CLI commands 140 by sending the argument to the converted XML template 130. At this time, if the network management system 100 requests transmission of the materialized CLI commands 140 via the network management interface 120, the materializer 122 requests the connection manager 123 to transmit the CLI commands 140 after completing the materialization.

In response to the transmission request input from the materializer 122, the connection manager 123 transmits the materialized CLI commands 140 to the network device 160. The network device 160 transmits transmitted result of the CLI commands to the result processor 124. The result processor 124 in response to the transmitted result analyzes whether execution of the CLI commands 140 is successful, and then sends the analyzed result to the connection manager 123.

In response to the analyzed result input from the result processor 124, the connection manager 123 sends the executed results of the CLI commands to the network management interface 120, and when an error occurred, reports the contents of the error.

According to a series of network management operations of the present invention, instead of converting policy information into CLI commands on a program, an XML template that can adequately express the hierarchical structure of the CLI commands is formed and used to generate actual CLI commands such that network management software is independent of the CLI syntax. Accordingly, even when an operating system of a device is upgraded, the network management system does not need to be changed, and in addition the maintenance of the network management system improves. Therefore, even for heterogeneous network devices using the SNM protocol or COPS protocol, the CLI-based network management system can be easily implemented and managed.

The present invention may be embodied in a code, which can be read by a computer, on a computer readable recording medium. The computer readable recording medium includes all kinds of recording apparatuses on which computer readable data is stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

According to the XML-based network management system and method of the present invention as described above, by combining the XML template stored in the memory and the argument provided to the XML template, the materialized CLI commands are generated and used to send policy information needed to the network device such that maintenance of the network management system improves. Accordingly, by reducing the maintenance problems and errors that can occur when managing network management software, the network device can be managed.

What is claimed is:

1. A network management system comprising:
an extensible markup language (XML) template in which the form of a command line interface (CLI) command supported by a network device is expressed in XML; and
a network management interface which converts the XML template into a tree-shaped internal data structure, and by providing a predetermined argument to the converted XML template, converts the XML template into a set of CLI commands that are to be transmitted to the network device.

2. The network management system of claim 1, wherein the network management interface comprises:
an XML parser which converts the XML template into the tree-shaped internal data structure;
a materializer which provides a predetermined argument to the converted XML template and converts the XML template into the set of CLI commands;
a connection manager which transmits the converted CLI commands to the network device; and
a result processor which determines whether the transmitted CLI commands are successfully executed and collects additional information.

3. The network management system of claim 1, wherein the network management interface is an X-CLI interface.

4. The network management system of claim 1, wherein the network management interface and the network device are connected through a protocol which provides a virtual terminal function to the network device.

5. The network management system of claim 1, wherein the XML template is described by using document type declaration (DTD) which is used to show the list of tags forming an XML document and to list the attributes of respective tags.

6. The network management system of claim 5, wherein the XML template comprises:
a first tag which is to indicate the possibility that a CLI tag appears in the XML document and the CLI tag includes subordinate CLI tags or character string data;
a second tag which is to specify the attributes of the CLI tag;
a third tag which indicates that the attributes specified by the second tag have character string data; and
a fourth tag which indicates the possibility that the attributes specified by the second tag are omitted.

7. The network management system of claim 6, wherein the attributes of the CLI tag specified by the second tag comprises:
a first attribute which is to identify a predetermined tag when a plurality of CLI tags exist at the same time;
a second attribute which is to actually indicate the CLI command;
a third attribute which is to display a prompt character string corresponding to the CLI command specified by the second attribute value, on a virtual terminal of the network device in order to transmit the CLI command;
a fourth attribute which indicates which prompt should be displayed on the virtual terminal of the network device after the CLI command is transmitted and executed;
a fifth attribute which specifies which character string is displayed on the virtual terminal of the network device when the result of executing the CLI command is a failure and determines whether the execution of the CLI command is a failure or a success; and
a sixth attribute which determines whether to execute a current CLI command when the execution of the previous CLI command is a failure.

8. The network management system of claim 7, wherein a CLI tag in which all the CLI tag attributes are omitted is a pure aggregation tag (PAT) in which subordinate CLI tags included in the PAT are capable of being materialized more than once.

9. A network management method comprising:
(a) forming an extensible markup language (XML) template in which the form of a command line interface (CLI) command supported by a network device is expressed by the XML; and
(b) converting the XML template into a tree-shaped internal data structure, and by providing a predetermined argument to the converted XML template, converting the XML template into a set of CLI commands that are to be transmitted to the network device.

10. The network management method of claim 9, wherein the step (b) comprises:
(b-1) converting the XML template into the tree-shaped internal data structure;
(b-2) providing a predetermined argument to the converted XML template and converting the XML template into the set of CLI commands;
(b-3) transmitting the converted CLI commands to the network device; and
(b-4) determining whether the transmitted CLI commands are successfully executed and collecting additional information.

11. The network management method of claim 9, wherein the network management interface is an X-CLI interface.

12. The network management method of claim 9, wherein the network management interface and the network device are connected through a protocol which provides a virtual terminal function to the network device.

13. The network management method of claim 9, wherein the XML template is described by using document type declaration (DTD) which is used to show the list of tags forming an XML document and to list the attributes of respective tags.

14. The network management method of claim 13, wherein the XML template comprises:
a first tag which is to indicate the possibility that a CLI tag to appears in the XML document and the CLI tag includes subordinate CLI tags or character string data;
a second tag which is to specify the attributes of the CLI tag;
a third tag which indicates that the attributes specified by the second tag have character string data; and
a fourth tag which indicates the possibility that the attributes specified by the second tag are omitted.

15. The network management method of claim 14, wherein the attributes of the CLI tag specified by the second tag comprises:
a first attribute which is to identify a predetermined tag when a plurality of CLI tags exist at the same time;
a second attribute which is to actually indicate the CLI command;
a third attribute which is to display a prompt character string corresponding to the CLI command specified by the second attribute value, on a virtual terminal of the network device in order to transmit the CLI command;
a fourth attribute which indicates which prompt should be displayed on the virtual terminal of the network device after the CLI command is transmitted and executed;
a fifth attribute which specifies which character string is displayed on the virtual terminal of the network device when the result of executing the CLI command is a failure and determines whether the execution of the CLI command is a failure or a success; and
a sixth attribute which determines whether to execute a current CLI command when the execution of the previous CLI command is a failure.

16. The network management method of claim 15, wherein a CLI tag in which all the CLI tag attributes are omitted is a pure aggregation tag (PAT) in which subordinate CLI tags included in the PAT are capable of being materialized more than once.

17. The network management method of claim 10, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

18. The network management method of claim 17, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

19. The network management method of claim 11, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

20. The network management method of claim 19, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

21. The network management method of claim 12, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

22. The network management method of claim 21, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

23. The network management method of claim 13, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

24. The network management method of claim 23, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

25. The network management method of claim 14, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

26. The network management method of claim 25, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

27. The network management method of claim 15, wherein step (b-3) comprises:
(b-3-1) setting a variable value indicating a failure of the execution of the CLI command to ‘false’ and setting variable i to the address value of a first materialized CLI command;
(b-3-2) while the variable i indicates an effective command, waiting till a predetermined prompt character string which is specified as the third attribute value is transmitted from the network device;
(b-3-3) if the prompt character string is transmitted, transmitting the CLI command to the network device; and
(b-3-4) if the network devices requests an additional input, transmitting a predetermined additional character string.

28. The network management method of claim 27, wherein step (b-4) comprises:
(b-4-1) when an error occurs as the result of the execution of the CLI command, setting the variable value indicating a failure of the execution of the CLI command to ‘true’; and
(b-4-2) by considering the state of the variable value indicating a failure of the execution of the CLI command and the branch location for a failure of the execution of the CLI command, storing in the variable i the next address value of a CLI command to be executed next.

29. A computer readable medium having embodied thereon a program for the method of claim 9.
